(19) United States
(12) Patent Application Publication
(10) Pub. No.: US 2005/0269369 A1
(43) Pub. Date: Dec. 8, 2005

(54) Rotary feeder valve for pneumatic conveying system

(76) Inventors: John W. Pfeiffer, Hughesville, PA (US); Anthony E. Boroch, Montoursville, PA (US)

Correspondence Address: Peter N. Lalos;Stevens, Davis,, Miller & Mosher, LLP, 1615 L Street, NW, Suite 850, Washington, DC, 20036-5622, US

(21) Appl. No.: 10/858,206

(22) Filed: Jun. 2, 2004

(51) Int. Cl. G01F 11/10

(52) U.S. Cl. 222/367

(57) ABSTRACT

A rotary valve for metering bulk materials generally consisting of a housing defining a chamber having a material inlet, a material outlet and a fluid inlet connectable with a source of fluid under pressure, a chamber having a cylindrical wall, a portion of which is formed of a liner of permeable material, spaced from a portion of the housing to provide an annular chamber displaced radially relative to the axis of the cylindrical wall and having an inlet communicable with a source of fluid under pressure; and a rotor disposed in the chamber coaxially with the cylindrical wall thereof, having a shaft journaled in bearings supported on end walls of the housing and a set of vanes disposed radially relative to the axis of such cylindrical wall, defining a plurality of pockets each communicable successively with the material inlet and both of the material outlet and the first mentioned fluid inlet to cause material to be received through the material inlet and discharged through the material outlet as the rotor is rotated.

This invention relates to a valve and more particularly to a valve for metering bulk solid fluidizable materials. The invention further contemplates an assembly consisting of a container holding bulk material and such a valve for dispensing material therefrom, and a system consisting of a container holding such material, a transport line and such valve for dispensing the material from the container into the transport line.

### BACKGROUND OF THE INVENTION

In many industries engaged in the handling of bulk materials, it typically is required to store such material and to transport it perhaps from one storage location to another or from a storage site to a processing site. Because of the nature of the material which often is very fine, it has very poor flowability. This often causes the material to lodge in containers and/or constrict or plug transport lines. In view of the nature of such material, it is the principal object of the present invention to provide a system for transporting bulk material in a freely flowing manner from one site to another. A more specific object of this invention is to provide a novel valve for a bulk material conveying system which is highly effective in dispensing bulk materials stored in a container into a transport line for conveying such material to another storage, transport or processing site.

### SUMMARY OF THE INVENTION

The objects of the invention are achieved by providing a rotary valve generally consisting of a housing defining a cylindrical chamber having a material inlet, a material outlet and a fluid inlet connectable to a source of fluid under pressure; a rotor disposed in the chamber coaxially therewith having a shaft journaled in walls of the housing and a set of vanes disposed radially relative to such axis, defining a plurality of pockets each communicable successively with the material inlet and then with both the material outlet and fluid inlet to cause material to be received through the material inlet and discharged through the material outlet as the rotor is rotated, each successive set of vanes having a liner formed of a permeable material extending from a tip of one of the vanes, along and spaced from the one vane, spaced from the shaft of the rotor and along and spaced from the other of the vanes to the tip thereof, defining a substantially V-shaped chamber; and means connectable to a source of fluid under pressure communicable with each of the V-shaped chambers when each of the pockets communicates with the material outlet. With such an arrangement, material transported from the material inlet of the valve to the material outlet of the valve, will be fluidized as it registers with the material outlet to facilitate the purging of the material from the pocket as a burst of fluid is injected into the pocket to discharge the material through the material outlet of the valve.

In the preferred embodiment of the invention, the material inlet is provided with a liner formed of a permeable material, spaced from the housing to provide a chamber, the rotor chamber is at least partially formed of a liner formed of a permeable material, spaced from the housing to provide a chamber, and such chambers also are provided with inlets communicable with a source of fluid under pressure. With such additional features, material fed through the material inlet of the valve will be fluidized to enhance its flowability, and material carried in a pocket registered with the material outlet of the valve will further be fluidized to enhance its discharge through the material outlet of the valve. Such a valve may be used merely to dispense bulk material from a container such as a vessel with a hopper or a bag with a spout or as a component of a system for dispensing bulk material from a container into a transport line.

### BRIEF DESCRIPTION OF THE DRAWINGS

FIG. 1 is a side elevational view of a system consisting of a vessel holding a supply of bulk solid fluidizable material, a material transport line and a valve embodying the present invention, used to receive material from the vessel and discharge it into the transport line;

FIG. 2 is an enlarged, perspective view of the valve shown in FIG. 1 and the transport line connected thereto;

FIG. 2a is an enlarged view of an air injection unit shown in FIG. 2, cooperating with an end of the rotor shaft of the valve;

FIG. 2b is an enlarged, cross-sectional view taken along line 2b-2b in FIG. 2;

FIG. 3 is a perspective view of the housing of the valve shown in FIG. 2;

FIG. 4 is a cross-sectional view taken along line 4-4 in FIG. 3;

FIG. 5 is a perspective view of the rotor of the valve shown in FIG. 2;

FIG. 6 is a cross-sectional view taken along line 6-6 in FIG. 5;

FIG. 7 is an enlargement of that portion of the rotor designated by the numeral 7 in FIG. 6;

FIG. 8 is a perspective view of an end wall of the housing of the valve shown in FIG. 2;

FIG. 9 is an enlarged, cross-sectional view taken along line 9-9 in FIG. 8;

FIG. 10 is a perspective view of the transport line shown in FIGS. 1 and 2;

FIG. 11 is an enlarged, cross-sectional view taken along line 11-11 in FIG. 10; and

FIG. 12 is an enlarged, front elevational view of the air injection unit shown in FIG. 2a.

### DETAILED DESCRIPTION OF AN EMBODIMENT OF THE INVENTION

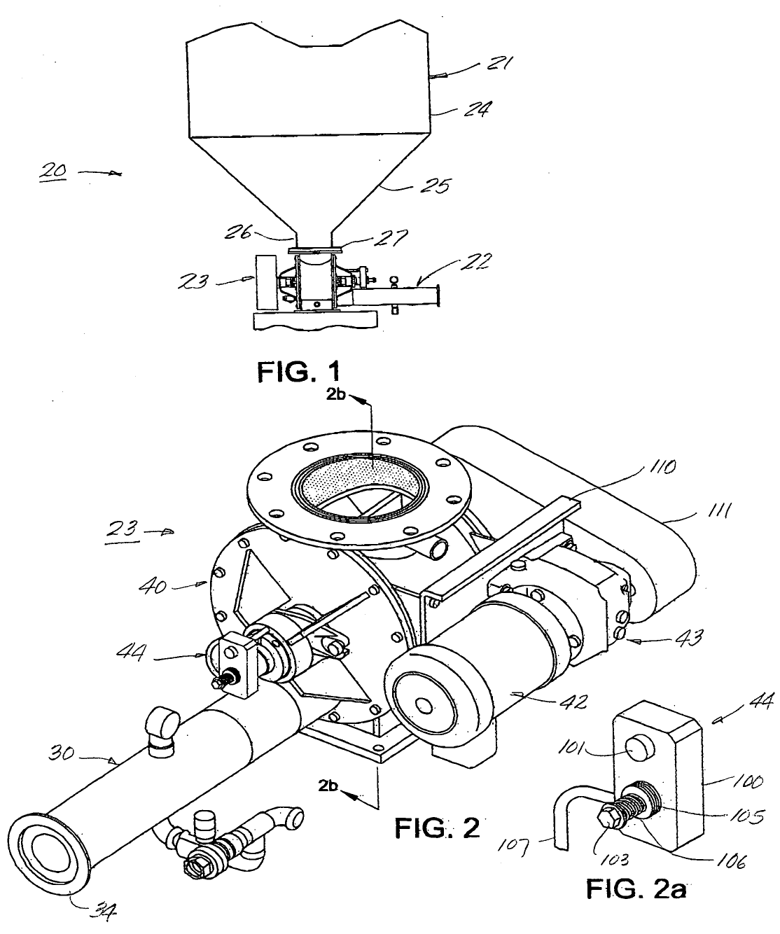

Referring to FIG. 1 of the drawings, there is illustrated a system 20 for handling a bulk material which generally consists of a vessel 21 for holding a supply of the material, a transport line 22 for conveying the material and a valve 23 for feeding material from the vessel to the transport line. Vessel 21 is of a conventional construction including a cylindrical section 24 which may be opened or closed at the upper end thereof, and a lower, frusto-conically configured hopper section 25 having an outlet neck 26 provided with a connecting flange 27. The vessel may be either open ended providing for gravity flow of the material therein or may be closed and pressurized to enhance flow. The hopper section also may be provided with a permeable liner through which air or another gas may be supplied to form a boundary layer along the liner consisting of a mixture of gas and material for enhancing the flowability of the material through the hopper and the outlet thereof.

Transport line 22 may be formed of a single elongated section or a number of sections comparable to the sections shown in FIGS. 10 and 11 provided with suitable end configurations, connected together in end to end relation. Referring to FIG. 11, section 30 which is adapted to be connected to valve 23 consists of an inner conduit 31 formed of a permeable material, an outer conduit 32 formed of an impermeable material, encompassing conduit 31 and spaced therefrom to provide a chamber 33, and an end connecting flange 34. Material being transported is pneumatically conveyed through inner conduit 31. The flow of such material is enhanced by the supply of air under pressure through an inlet connected to an air manifold, which flows into chamber 33 and through the micropores of inner conduit 31 to form a boundary layer along the inner surface of conduit 31 consisting of a mixture of gas and material particles. In transporting such material over various distances, a number of sections comparable to those sections as shown in FIGS. 10 and 11, having connecting flanges at the ends thereof, may be connected together to form a transport line. Sections of such a line also can be appropriately configured to convey the material upwardly, downwardly and laterally. Such a transport line may be used to convey the material to another storage site, a transport vehicle such as a truck body, a rail car or the hold of a ship, or a piece of processing equipment such as a mixer, blender and the like. Various enhancements of the transport line may be provided such as varying the pressure of the fluidizing gas along the length of the transport line, periodically injecting a burst of high pressure gas into chambers 33 for removing material clogging the pores of inner conduits 31 and the like.

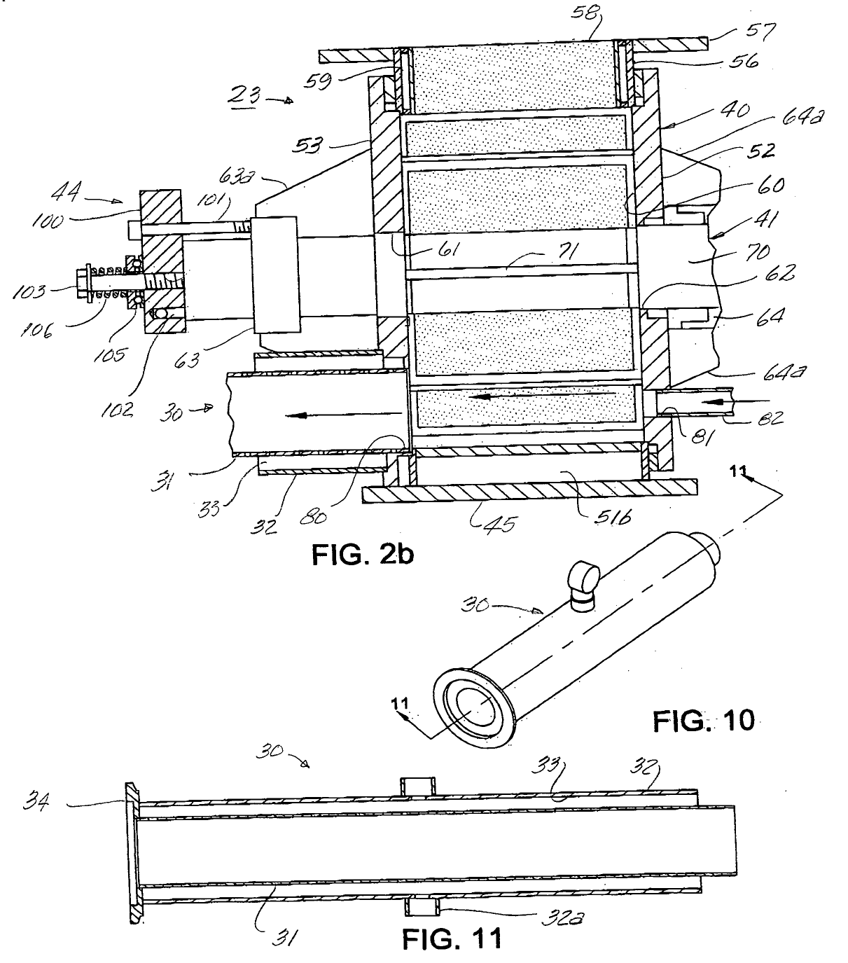

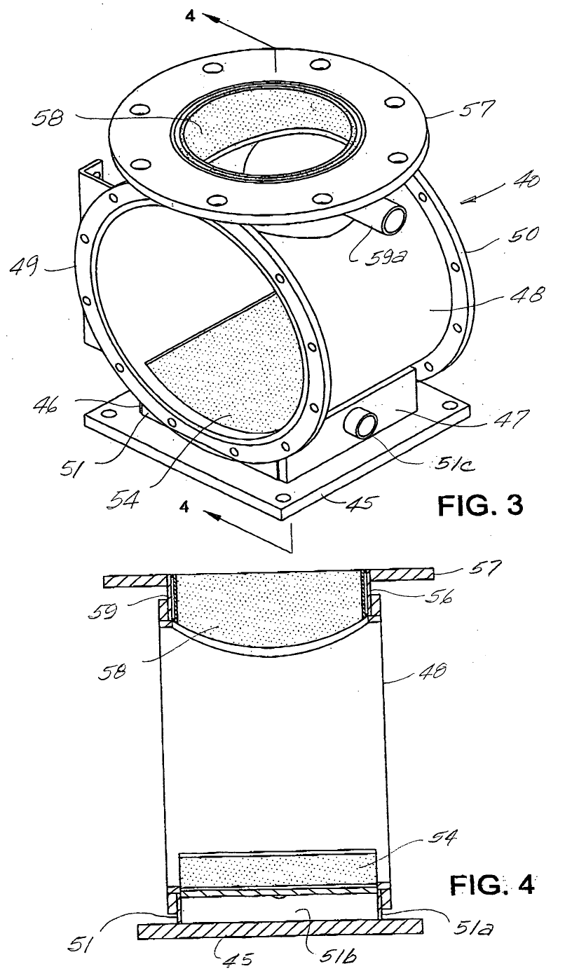

Valve assembly 23 generally consists of a housing 40, a rotor 41 mounted in the housing, a motor 42 provided with a gear reduction unit 43 mounted on the valve housing and operatively connected to the rotor and an air injector unit 44 supported on a bearing housing mounted on the valve body and cooperable with the rotor. As best shown in FIGS. 2b, 3 and 4, the housing includes a base unit 45 which is adapted to support the valve on a surface, a pair of spaced, lower side walls 46 and 47 mounted on the base member, a cylindrical member 48 seated on lower side walls 46 and 47, spaced from the base member and having a pair of axially spaced annular mounting flanges 49 and 50, a pair of spaced, front and rear lower end walls 51 and 51a and a pair of upper end walls 52 and 53. The lower end of cylindrical member 48 cooperates with base member 45, side support walls 46 and 47 and front and rear end walls 51 and 51a to define a closed chamber 51b which is provided with an air inlet 51c as best shown in FIG. 3. A lower sector of cylindrical member 48 has been removed and supplanted with an arcuate segment 54 formed of a permeable material. Segment 54 forms an upper wall of chamber 51a so that air under pressure supplied to chamber 52 through inlet 53 will permeate through segment 54.

The upper end of cylindrical member 48 is provided with an opening to accommodate a neck member 56, disposed radially relative to the axis of cylindrical member 48 and having an annular mounting flange 57 connectable to connecting flange 27 of vessel 21. As best shown in FIGS. 2b and 4, neck member 56 is provided with an annular liner 58 formed of a permeable material, spaced from the neck member to form an annular chamber 59 which is closed at the upper and lower ends thereof by welding. Such chamber also is provided with an inlet 59a for supplying air or another gas under pressure to chamber 59 which is caused to permeate permeable liner 58.

End walls 52 and 53 are mounted on flanges 49 and 50 by means of sets of bolts to cooperate with cylindrical wall member 48 to provide a cylindrical rotor chamber 60. A pair of O-rings may be provided between the end walls and the mounting flanges to seal the rotor chamber. Alternatively, one of the end walls may be welded to cylindrical wall member 48. The end walls further are provided with a pair of openings 61 and 62 disposed coaxially with cylindrical wall member 48, and a pair of bearing housings 63 and 64 also disposed coaxially with cylindrical wall member 48, supported on the exterior sides of the end walls 52 and 53 by sets of circumferentially spaced brackets 63a and 64a, respectively.

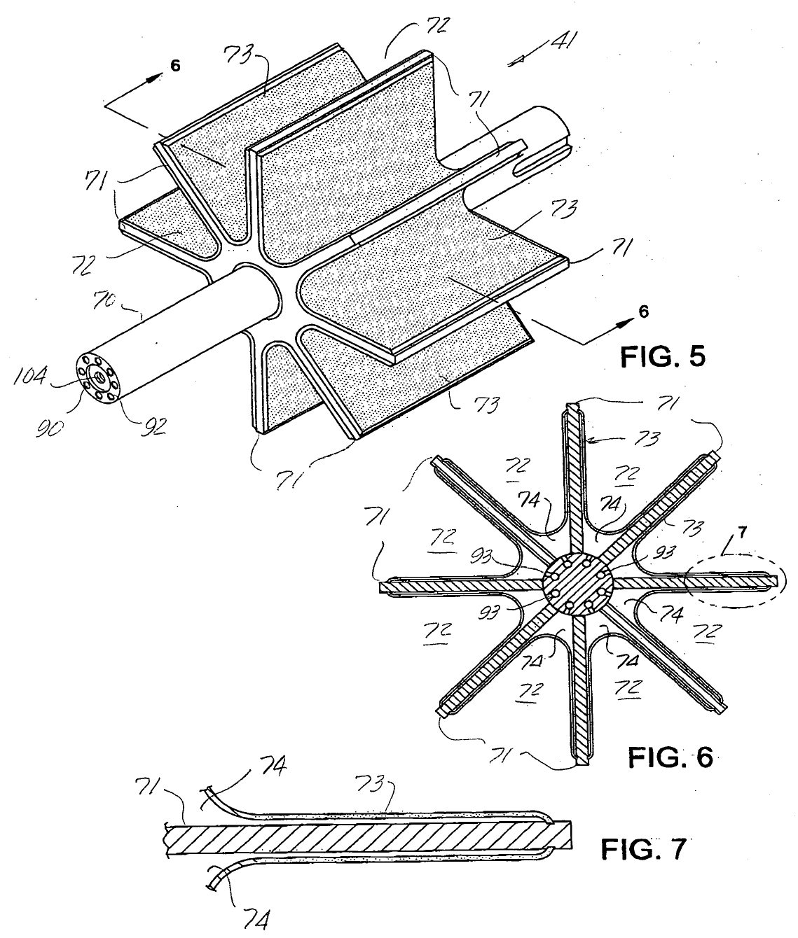

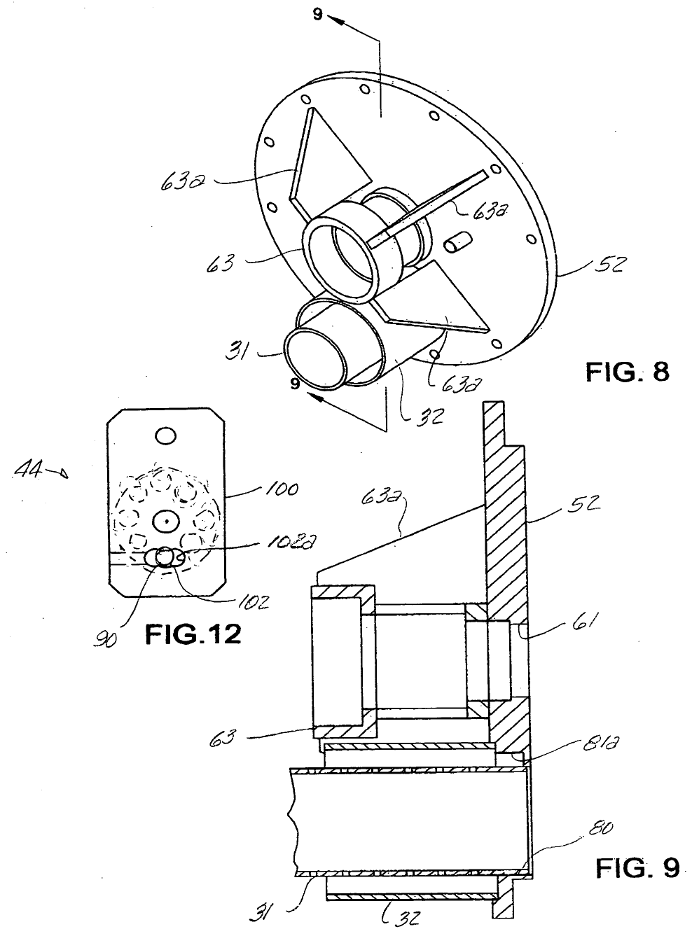

Referring to FIGS. 5 through 7, rotor 41 includes a shaft 70, a plurality of radially disposed, circumferentially spaced vanes 71 forming a plurality of circumferentially spaced pockets 72 and a plurality of substantially V-shaped liners 73 each being disposed between a successive set of vanes, having the free ends of the leg portions thereof secured to the successive vanes adjacent the ends thereof, having a rounded portion between the diverging legs thereof and being spaced from the surfaces of the successive vanes and a portion of the shaft to provide a chambers 74. The substantially V-shaped chambers formed by successive vanes 71 and liners 73 are closed at the ends thereof adjacent housing end walls 52 and 53 by welding or other suitable means.

Rotor 41 is disposed in housing chamber 60 with one end of shaft 70 extending through side wall opening 61 and journaled in a bearing mounted n housing 63 and the other end of the shaft extending through side wall opening 62 and journaled in a bearing mounted in housing 64, with each of the vanes spanning the distance between the inner surfaces of end walls 52 and 53 and projecting radially to the inner surface of cylindrical member 48. It will be appreciated that as the rotor is rotated, material introduced through neck member 56 will be received in a pocket 72 of the rotor and carried to a position at a lower end of the rotor chamber diametrically opposed to the material inlet where the pocket will be longitudinally aligned with a material outlet opening 80 provided in the lower end of housing end wall 52 and a gas inlet opening 81 disposed in the lower end of housing end wall 53, coaxially with material outlet 80. Received within material outlet 80 is inner, permeable conduit 31 of transport line 30, with outer, impermeable conduit 32 engaging and sealed and supported by welding or other means to housing end wall 52. Inserted in fluid inlet 81 is a fluid nozzle 82 which is connected to a source of fluid under pressure having suitable controls. It further will be appreciated that when a pocket 72 of the rotor filled with material received through the material inlet of the valve is positioned in registry with permeable conduit 31 and nozzle 82, and fluid under pressure is injected through nozzle 82, material within such loweredly disposed pocket will be purged therefrom and impelled through inner, permeable conduit 31.

Air injected through inlet coupling 32a, annular chamber 32 and porous conduit 31 forms a boundary layer along the inner surface of conduit 31, consisting of a mixture of air and material being handled, which functions to enhance the flow of material through conduit 31. As best seen in FIG. 9, the outer, upper end of opening 80 is counterbored eccentrically relative to the axis of opening 80, as at 81a, to cause fluidizing air to be rejected into opening 80 and thus prevent clogging of material at such opening.

As best shown in FIGS. 5 and 6, rotor shaft 70 is provided with a plurality of passageways 90 spaced circumferentially relative to the axis of the rotor, each having an inlet port on a front end face 92 of shaft 70 and an outlet port 93 communicating with a chamber 74. Each of such passageways is adapted to receive a burst of air under pressure from injector unit 44 when a cooperating pocket 72 is disposed in a lowermost position in registry with material outlet 80 and nozzle inlet 81 to supply air through a respective chamber 74 and through a liner 73 to fluidize material in such pocket and thus facilitate the purging of the material from the pocket.

One end of rotor shaft 70 extends through opening 61, is journaled in the bearing mounted in housing 63 and extends beyond bearing housing 63. Injection unit 44 consists of a block 100 supported on bearing housing 63 by means of a bolt 101, is disposed against shaft end surface 92 and is provided with a passageway 102 which is adapted to be registered with the lowermost of passageway inlet ports 90. The unit further is provided with a bolt 103 extending through an opening in block 100 and threaded into an axially disposed, threaded opening 104 in the rotor shaft. Mounted on such bolt is a thrust bearing 105 seated on an outer surface of block 100, and a spring 106 interposed between the thrust bearing and the head portion of bolt 103. Passageway 102 is adapted to be connected by means of a line 107 to a source of gas under pressure provided with suitable controls.

As best shown in FIG. 12, at least the outlet of passageway 102 in block 100 of the injector device has an arcuate length relative to the rotor axis slightly greater than the diameter of an inlet 90 of the rotor, as at 102a, so that as the rotor rotates and an inlet 90 communicates with outlet 102, the dwell time of communication will be greater than if the outlet 102 was simply a circular port having the same diameter as an inlet port 90. The arcuate length of passageway portion 102a may vary depending on the amount of fluidizing gas to be supplied to a pocket of the rotor and the selected operating speed of the valve. Alternatively, instead of increasing the arcuate length of passageway 102, such passageway simply may be provided with a larger diameter than an input port 92, assuming sufficient space is provided and adequate sealing may be effected.

The arcuate configuration of outlet 102 is relative to the rotor axis. The dwell time of the injection of fluid into a rotor pocket positioned at the lower end of the rotor chamber, can be varied by varying the angle in a plane disposed perpendicular to the rotor axis, defined by a pair of radial lines extending from the rotor axis to the ends of outlet 102. It is contemplated that block 100 will be formed of an easily machinable, wear resistant and low friction material such as Rulon or Nylatron, permitting slot 102 to be milled.

As shown in FIG. 2, a mounting plate 110 is provided on a side of the housing, on which gear reduction unit 43 is mounted. Motor 42 consisting of an electric motor is mounted on and operatively connected to gear reduction unit 43. Drive is transmitted from an output shaft of the gear reduction unit to the rear end of rotor shaft 70 by means of a pair of pulleys mounted on such shafts connected by a timing belt or roller chain. A housing 111 is provided for covering such drive components.

The materials from which liners 55, 58 and 73 are formed may be of any suitable permeable material allowing a supply of gas under pressure to permeate the liners and create a fluidized boundary layer consisting of the permeated gas and particles of the material being conveyed. A suitable material preferred for use in such liners is sold by The Young Industries, Inc. of Muncy, Pa., USA, under the trademark TRANSFLOW. In most applications, merely compressed air typically available in industrial facilities may be used for fluidizing the material passing through the valve, and for purging the material from the valve and impelling it through the transport line. In applications where the material being processed may be reactive with air, other compatible gases including inert gases may be used both to fluidize and impel the material.

In the use of the system shown in FIG. 1 to dispense a bulk material deposited in vessel 21 and convey such material through transport line 22 to a remote site, air under pressure is supplied to chamber or chambers 33 of transport line 30, and air under pressure similarly is supplied to any aerated portion of hopper 25, chamber 51b at the lower end of the valve housing, chamber 59 at the upper end of the valve housing and injector device 44. Motor 43 is then operated to rotate the rotor. Air supplied to the aerated portion of hopper 25 forms a fluidized boundary layer in the hopper to facilitate the gravity flow of material through vessel 21 into the valve through neck member 56. As material is introduced into the upper end of the valve, the flow of such material is enhanced by the fluidized boundary layer formed by air supplied to chamber 61 and permeated through liner 58. Material thus deposited in the pockets of the rotor is transported to the lower end of the valve into alignment with permeable conduit 31 and nozzle 82 which injects a stream of gas through the registered pocket to purge the material from the pocket and impel it through permeable conduit 31. The purging action of the air injected through nozzle 82 is enhanced by the supply of air through injector device 44, a passageway 90 in rotor shaft 70 and a chamber 74 of a pocket disposed in registry with nozzle 82 and permeable conduit 31 which permeates through a liner 74 to cooperate with air permeating through liner 55 to form a fluidized boundary layer about the perimeter of the pocket. Such air permeating liners 74 and 55 function to dislodge any material within the pocket being purged. The rounded portion of each liner 74 between the leg portions thereof further functions to preclude the lodging of material in the inner area of each pocket. As the rotor rotates causing a pocket at a lower end of the valve to traverse past nozzle 82 and permeable conduit 31, the supply of fluidizing gas to chamber 74 of such pocket is prolonged by the arcuate length of passageway 102.

The free flow of material through valve 23 promoted by the fluidized boundary layers provided by permeable liners 54, 58 and 73 permits the accurate metering of material simply by controlling the speed of the motor operating the rotor. For some materials, depending upon their flow properties, one or both of liners 58 and 73 may be omitted with good results. It is preferred, however, that all three liners be employed particularly the liners defining the pocket area being purged at the lower of the valve.

Although a fluidized transport line is used in the embodiment of the invention described, it is within the contemplation of the invention for the use of the valve as described with any type of transport line. A fluidized transport line, however, is preferred in providing a controlled flow rate throughout the system. In addition to the material outlet of the valve being disposed in an end wall of the valve, substantially parallel to the centerline of the rotor, such material outlet could be disposed radially relative to the axis of the rotor with the purging gas being introduced through a suitable passageway in the rotor. Furthermore, although the material inlet of the valve is illustrated and described as being disposed at the upper end of the valve, such material input may be positioned with a centerline disposed at an angle to the vertical.

In addition to inlet ports 90 of shaft 70 and outlet port 102 of block 100 lying in a plane disposed perpendicular to the rotor axis, such ports may lie in a cylindrical plane relative to the rotor axis.

From the foregoing detailed description, it will be evident that there are a number of changes, adaptations and modifications of the present invention that come within the province of those having ordinary skill in the art to which the present invention pertains. However, it is intended that all such variations not departing from the spirit of the invention be considered as within the scope thereof as limited solely by the following claims.

1. A rotary valve for metering bulk materials comprising:
a housing defining a cylindrical chamber having a material inlet, a material outlet and a fluid inlet connectable with a source of fluid under pressure;
a rotor disposed in said chamber coaxially therewith having a shaft supported on walls of said housing and a set of vanes disposed radially relative to said axis, defining a plurality of pockets each communicable successively with said material inlet and both of said material outlet and fluid inlet to cause material to be received through said material inlet and discharged through said material outlet as said rotor is rotated, each successive set of vanes having a liner formed of a permeable material extending from a tip of one of said vanes, along and spaced from said one vane, spaced from said rotor and along and spaced from the other of said vanes to the tip thereof, defining a substantially V-shaped chamber; and
means connectable to a source of fluid under pressure communicable with each of said V-shaped chambers when each of said pockets communicates with said material outlet.

2. A valve according to claim 1 wherein said material inlet is disposed radially relative to said axis.

3. A valve according to claim 1 wherein said material outlet is displaced radially relative to said axis.

4. A valve according to claim 1 wherein said fluid inlet is displaced radially relative to said axis.

5. A valve according to claim 1 wherein said material inlet is disposed at an upper end of said housing, radially relative to said axis, and both of said material outlet and fluid inlet are disposed at a lower end of said housing, in alignment, and are displaced radially relative to said axis.

6. A valve according to claim 1 wherein said means connectable to a source of fluid under pressure and communicable with said V-shaped chambers includes a plurality of fluid passageways each having an outlet communicating with one of said V-shaped chambers of a rotor pocket and an inlet port communicable with an outlet port of a fluid injector communicable with said source of fluid under pressure, when said pocket communicates with said material outlet.

7. A valve according to claim 6 wherein said inlet ports of said passageway are circumferentially spaced relative to said axis, and said outlet port of said fluid injector is displaced radially relative to said axis.

8. A valve according to claim 7 wherein said outlet port of said fluid injector has a greater arcuate dimension relative to said axis than a width of each of said inlet ports of said passageways.

9. A valve according to claim 8 wherein the dwell time of the injection of fluidizing gas into said V-shaped chamber is a function of the degree of differences in said arcuate dimension of the outlet port of said fluid injector and the width of said inlet port of said passageway communicating with said V-shaped chamber.

10. A valve according to claim 7 wherein said inlet ports of said passageways and said outlet port of said injector lie in a plane disposed perpendicular to said axis.

11. A valve according to claim 7 wherein said inlet ports of said passageways and said outlet port of said injector lie in a cylindrical plane disposed coaxially with said axis.

12. A valve according to claim 1 wherein said material inlet is provided with a liner formed of a permeable material spaced from said housing to provide a material inlet encompassing chamber, and said material inlet encompassing chamber is provided with an inlet communicable with a source of fluid under pressure.

13. A valve according to claim 12 wherein said material inlet liner is annular.

14. A valve according to claim 1 wherein said rotary chamber is at least partially formed of a liner formed of a permeable material, spaced from said housing to provide a chamber displaced radially relative to said axis, and said radially displaced chamber is provided with an inlet communicable with a source of fluid under pressure.

15. A valve according to claim 14 wherein said rotary chamber liner is arcuate consisting of a segment of a cylinder.

16. A valve according to claim 15 wherein said rotary chamber liner has an arcuate dimension no less than the arcuate dimension between the tips of a pair of successive vanes of said rotor.

17. A valve according to claim 15 wherein a plane including said axis, intersects said rotary chamber liner and said material outlet.

18. A valve according to claim 17 wherein said plane bisects said rotary chamber liner and said material outlet.

19. A valve according to claim 17 wherein said rotary chamber liner cooperates with the V-shaped liner of a registered pocket to introduce a fluidizing fluid into said registered pocket to dislodge material deposited therein and enhance the purging thereof.

20. A valve according to claim 1 including a motor mounted on said housing and means for transferring drive from said motor to said rotor axes.

21. A bulk material dispensing assembly comprising:
means for holding said bulk material having an outlet; and
a rotary valve including a housing defining a cylindrical chamber having a material inlet communicating with said outlet of said holding means for receiving material therethrough, a material outlet and a fluid inlet connectable to a source of fluid under pressure; a rotor disposed in said chamber coaxially therewith having a shaft journaled in bearings supported on walls of said housing and a set of vanes disposed radially relative to said axis, defining a plurality of pockets each communicable successively with said material inlet and both of said material outlet and fluid inlet to cause material to be received through said material inlet and discharged through said material outlet as said rotor is rotated, each successive set of vanes having a liner formed of a permeable material extending from a tip of one of said vanes, along and spaced from said one vane, spaced from said rotor and along and spaced from the other of said vanes to the tip thereof defining a substantially V-shaped chamber; and means connectable to a source of fluid under pressure communicable with each of said V-shaped chambers when each of said pockets communicates with said material outlet.

22. An assembly according to claim 21 wherein said holding means comprises a vessel having a frusto-conically configured lower end including said outlet thereof.

23. An assembly according to claim 22 wherein said vessel includes means for enhancing the gravity flow of material therefrom.

24. An assembly according to claim 23 wherein said flow enhancing means comprises means for supplying a material fluidizing fluid therein.

25. An assembly according to claim 21 wherein said material inlet port of said valve is provided with a liner formed of a permeable material, spaced from said housing to provide a material inlet encompassing chamber, and said material inlet encompassing chamber is provided with an inlet communicable with a source of fluid under pressure.

26. An assembly according to claim 25 wherein said material inlet liner is annular.

27. An assembly according to claim 21 wherein said rotary chamber of said valve is at least partially formed of a liner, formed of a permeable material, spaced from said housing to provide a chamber radially displaced relative to said axis, and said radially displaced chamber is provided with an inlet port communicable with a source of fluid under pressure.

28. An assembly according to claim 27 wherein said rotary chamber liner is arcuate, consisting of a segment of a cylinder.

29. An assembly according to claim 28 wherein said rotary chamber liner has an arcuate dimension no less than the arcuate dimension between the tips of a pair of vanes of said rotor, relative to the axis of said rotor chamber.

30. An assembly according to claim 21 including a motor mounted on said valve housing and means for transmitting said drive from said motor to said rotor of said valve.

31. A system for handling bulk material comprising:
means for holding said bulk material, having an outlet;
a material transport line including an inner conduit formed of a permeable material, an outer conduit formed of an impermeable material encompassing said inner permeable conduit and spaced therefrom to provide an annular chamber therebetween, and means for supplying fluid under pressure to said annular chamber of said material transport line; and
a rotary valve including a housing defining a cylindrical chamber having a material inlet communicating with the outlet of said holding means, a material outlet communicable with the inner, permeable conduit of said transport line and a fluid inlet connectable to a source of fluid under pressure; a rotor disposed in said chamber coaxially therewith having a shaft journaled in walls of said housing and a set of vanes disposed radially relative to said axis, defining a plurality of pockets each communicable successively with said material inlet and both of said material outlet and said fluid inlet to cause material to be received through said material inlet and discharged through said material outlet as said rotor is rotated, each successive set of vanes having a liner formed of a permeable material extending from a tip of one of said vanes, along and spaced from said one vane, spaced from said rotor and along and spaced from the other of said vanes to a tip thereof defining a substantially V-shaped chamber; and means connectable to a source of fluid under pressure communicable with each of said V-shaped chambers when each of said pockets communicates with said material outlet.

32. A system according to claim 31 wherein said holding means comprises a vessel having a frusto-conically configured lower end including said inlet thereof.

33. A system according to claim 32 wherein said vessel includes means for enhancing the gravity flow of material therefrom.

34. A system according to claim 32 wherein said flow enhancing means comprises means for supplying a material fluidizing fluid therein.

35. A system according to claim 31 wherein said material inlet port of said valve is provided with a liner formed of a permeable material, spaced from said housing to provide a material inlet encompassing chamber, and said material inlet encompassing chamber is provided with an inlet communicable with a source of fluid under pressure.

36. A system according to claim 35 wherein said material inlet liner is annular.

37. A system according to claim 31 wherein said rotary chamber of said valve is at least partially formed of a liner formed of a permeable material spaced from said housing to provide a radially displaced chamber, and said radially displaced chamber is provided with an inlet port communicable with a source of fluid under pressure.

38. A system according to claim 31 wherein said rotary chamber liner is arcuate, consisting of a segment of a cylinder.

39. A system according to claim 38 wherein said rotary chamber liner has an arcuate dimension no less than the arcuate dimension between the tips of a pair of vanes of said rotor, relative to the axis of said rotor.

40. A system according to claim 31 including a motor mounted on said valve housing and means for transmitting drive from said motor to said rotor of said valve.

41. A rotary valve for metering bulk materials comprising:
a housing defining a chamber having a material inlet, a material outlet and a fluid inlet connectable with a source of fluid under pressure, said chamber having a cylindrical wall, a portion of which is formed of a liner of permeable material, spaced from a portion of said housing to provide a chamber displaced radially relative to the axis of said cylindrical wall and having an inlet communicable to a source of fluid under pressure; and
a rotor disposed in said chamber coaxially with said cylindrical wall thereof, having a shaft journaled in bearing supported on walls of said housing and a set of vanes disposed radially relative to said axis, defining a plurality of pockets each communicable successively with said material inlet and both of said material outlet and said first mentioned fluid inlet to cause material to be received through said material inlet and discharged through said material outlet as said rotor is rotated.

42. A valve according to claim 41 wherein said portion of said cylindrical wall formed of a liner of permeable material is disposed between said material outlet and said first mentioned fluid inlet.

43. A valve according to claim 41 wherein said material outlet comprises a circular opening in an end wall of said housing for receiving an inner cylindrical wall of a material conveying conduit.

44. A valve according to claim 43 wherein said circular opening includes an eccentric bore on an outer side of said housing communicable with an annular chamber of said material conveying conduit when said material conveying conduit comprises an inner cylindrical member formed of a permeable material, receivable within said material outlet of said housing, and an outer cylindrical member encompassing said inner cylindrical member and spaced therefrom to provide said annular chamber, formed of a impermeable material.
